(19) United States
(12) Patent Application Publication
(10) Pub. No.: US 2003/0169206 A1
(43) Pub. Date: Sep. 11, 2003

(54) Antenna apparatus for radio set

(76) Inventor: Kiyoshi Egawa, Minato-ku (JP)

Correspondence Address: STEVENS DAVIS MILLER & MOSHER, LLP, 1615 L STREET, NW, SUITE 850, WASHINGTON, DC, 20036, US

(21) Appl. No.: 10/398,121

(22) PCT Filed: Aug. 6, 2002
(86) PCT No.: PCT/JP02/08007

(30) Foreign Application Priority Data
Aug. 8, 2001 (JP) 2001-241381

(51) Int. Cl. H01Q 1/24

(52) U.S. Cl. 343/702

(57) ABSTRACT

An antenna apparatus for a radio set capable of reducing influences from the human body, improving the gain and reducing a non-absorption ratio (SAR) without narrowing the communication area. The apparatus according to the present invention is an unbalanced power supply type antenna apparatus for a radio set provided with a power-supplied antenna element 1 and a base plate 3, wherein a tabular parasitic element 7 is placed along the base plate 3 and the length of the parasitic element 7 is set so that the tabular parasitic element 7 operates as a reflector when placed on the human body side and operates as a wave director when placed on the opposite side of the human body.

### TECHNICAL FIELD

The present invention relates to an antenna apparatus for a radio set.

### BACKGROUND ART

FIG. 1 shows an example of an antenna apparatus used for a portable mobile radio set (also referred to as “portable mobile communication terminal” or simply referred to as “portable communication terminal,” etc.) such as a cellular phone and mobile radio set.

This antenna apparatus is an antenna apparatus for a cellular phone, and is an unbalanced power supply antenna composed of a power-supplied antenna element 1 and a base plate 3 such as a circuit board. Here, the antenna element 1 can have any shape such as linear, spiral or tabular. Power is supplied to the antenna element 1 through a power supply section 5. The length of the base plate 3 (base plate length) varies depending on the frequency band of the system used or model of the cellular phone set, but it is often approximately ⅜ wavelength for an 800 MHz band.

However, in the case of the above-described conventional antenna apparatus, a current flows through the base plate 3 during a communication and the base plate 3 also radiates as part of the antenna (unbalanced power supply system), and therefore the problem is that it is likely to receive influences from the human body and lose gain during a communication.

Furthermore, a conventional antenna apparatus would increase antenna loss or decrease transmit power of the cellular phone set to reduce a non-absorption ratio (SAR), causing a problem of narrowing the communication area.

### DISCLOSURE OF INVENTION

It is an object of the present invention to provide an antenna apparatus for a radio set capable of reducing influences from the human body, improving gain and reducing the non-absorption ratio (SAR) without narrowing the communication area.

An essence of the present invention is to provide an unbalanced power supply type antenna apparatus for a radio set provided with a power-supplied antenna element and a base plate, wherein a parasitic element is placed along the base plate and this parasitic element is configured so as to operate as a reflector when placed on the human body side and operate as a wave director when placed on the opposite side of the human body.

An antenna apparatus for a radio set according to an aspect of the present invention includes a power-supplied antenna element, a base plate and a tabular parasitic element placed along the base plate, wherein the length of the element is set so that the tabular parasitic element operates as a reflector when placed on the human body side with respect to the base plate and operates as a wave director when placed on the opposite side of the human body.

An antenna apparatus for a radio set according to another aspect of the present invention includes a power-supplied antenna element, a base plate and a frame-shaped parasitic element placed along the base plate, wherein the length of the frame-shaped parasitic element is set so that the frame-shaped parasitic element operates as a reflector when placed on the human body side with respect to the base plate and operates as a wave director when placed on the opposite side of the human body.

An antenna apparatus for a radio set according to a further aspect of the present invention includes a power-supplied antenna element having a plurality of resonance points corresponding to a plurality of frequency bands, a base plate and a frame-shaped parasitic element body having as many frame-shaped parasitic elements as the resonance points placed along the base plate, wherein the frame-shaped parasitic element body includes switching sections for switching ON/OFF states of conduction inserted between neighboring frame-shaped parasitic elements, and the length of each frame-shaped parasitic element and the location of each switching section are set so that the frame-shaped parasitic element body operates as a reflector at each resonance point when placed on the human body side with respect to the base plate and operates as a wave director at each resonance point when placed on the opposite side of the human body.

An antenna apparatus for a radio set according to a still further aspect of the present invention includes a power-supplied antenna element having a plurality of resonance points corresponding to a plurality of frequency bands, a base plate and a frame-shaped parasitic element body having as many frame-shaped parasitic elements as resonance points placed along the base plate, wherein the frame-shaped parasitic element body includes inductive elements for switching ON/OFF states of conduction by means of high frequency inserted between neighboring frame-shaped parasitic elements, and the length of each frame-shaped parasitic element and a constant of each inductive element of each switching section are set so that the frame-shaped parasitic element body operates as a reflector at each resonance point when placed on the human body side with respect to the base plate and operates as a wave director at each resonance point when placed on the opposite side of the human body.

An antenna apparatus for a radio set according to a still further aspect of the present invention includes a power-supplied antenna element having a plurality of resonance points corresponding to a plurality of frequency bands, a base plate and a linear parasitic element body having as many linear parasitic elements as resonance points placed along the base plate, wherein the linear parasitic element body includes switching sections for switching ON/OFF states of conduction inserted between neighboring linear parasitic elements, and the length of each linear parasitic element and the location of each switching section are set so that the linear parasitic element body operates as a reflector at each resonance point when placed on the human body side with respect to the base plate and operates as a wave director at each resonance point when placed on the opposite side of the human body.

An antenna apparatus for a radio set according to a still further aspect of the present invention includes a power-supplied antenna element having a plurality of resonance points corresponding to a plurality of frequency bands, a base plate and a one-side-grounded linear parasitic element placed along the base plate, whose one end is grounded to the base plate, wherein the one-side-grounded linear parasitic element is grounded to the base plate through switching sections for switching ON/OFF states of conduction at as many intermediate positions as resonance points, and the length of the element and the location of each switching section are set so that the one-side-grounded linear parasitic element operates as a reflector at each resonance point when placed on the human body side with respect to the base plate and operates as a wave director at each resonance point at each resonance point when placed on the opposite side of the human body.

An antenna apparatus for a radio set according to a still further aspect of the present invention includes a power-supplied antenna element, a base plate and a one-side-grounded tabular parasitic element placed along the base plate, whose one end is grounded to the base plate, wherein the length of the one-side-grounded tabular parasitic element is set so that the one-side-grounded tabular parasitic element operates as a reflector when placed on the human body side with respect to the base plate and operates as a wave director when placed on the opposite side of the human body.

An antenna apparatus for a radio set according to a still further aspect of the present invention includes a power-supplied antenna element, a base plate and a one-side-grounded frame-shaped parasitic element placed along the base plate, whose one end is grounded to the base plate, wherein the length of the one-side-grounded frame-shaped parasitic element is set so that the one-side-grounded frame-shaped parasitic element operates as a reflector when placed on the human body side with respect to the base plate and operates as a wave director when placed on the opposite side of the human body.

An antenna apparatus for a radio set according to a still further aspect of the present invention includes a power-supplied antenna element and abase plate, wherein the base plate has a length of substantially ½ wavelength.

An antenna apparatus for a radio set according to a still further aspect of the present invention includes a power-supplied antenna element and abase plate, wherein the base plate is provided with an extension element at the bottom to electrically extend the length of the base plate to substantially ½ wavelength.

### BRIEF DESCRIPTION OF DRAWINGS

FIG. 1 is a block diagram showing a configuration of a conventional antenna apparatus for a radio set;

FIG. 2 is a block diagram showing a configuration of an antenna apparatus for a radio set according to Embodiment 1 of the present invention;

FIG. 3A is a directivity characteristic diagram showing an emission characteristic (when a parasitic element is placed on the human body side) of the antenna. apparatus for a radio set according to Embodiment 1;

FIG. 3B is a directivity characteristic diagram showing an emission characteristic (when a parasitic element is placed on the opposite side of the human body) of the antenna apparatus for a radio set according to Embodiment 1;

FIG. 4 is a block diagram showing a configuration of an antenna apparatus for a radio set according to Embodiment 2 of the present invention;

FIG. 5 is a block diagram showing a configuration of an antenna apparatus for a radio set according to Embodiment 3 of the present invention;

FIG. 6 is a block diagram showing a configuration of an antenna apparatus for a radio set according to Embodiment 4 of the present invention;

FIG. 7 is a block diagram showing a configuration of an antenna apparatus for a radio set according to Embodiment 5 of the present invention;

FIG. 8 is a block diagram showing a configuration of an antenna apparatus for a radio set according to Embodiment 6 of the present invention;

FIG. 9 is a block diagram showing a configuration of an antenna apparatus for a radio set according to Embodiment 7 of the present invention;

FIG. 10 is a block diagram showing a configuration of an antenna apparatus for a radio set according to Embodiment 8 of the present invention;

FIG. 11 is a block diagram showing a configuration of an antenna apparatus for a radio set according to Embodiment 9 of the present invention;

FIG. 12 is a block diagram showing a configuration of an antenna apparatus for a radio set according to Embodiment 10 of the present invention; and

FIG. 13 is a block diagram showing a configuration of an antenna apparatus for a radio set according to Embodiment 11 of the present invention.

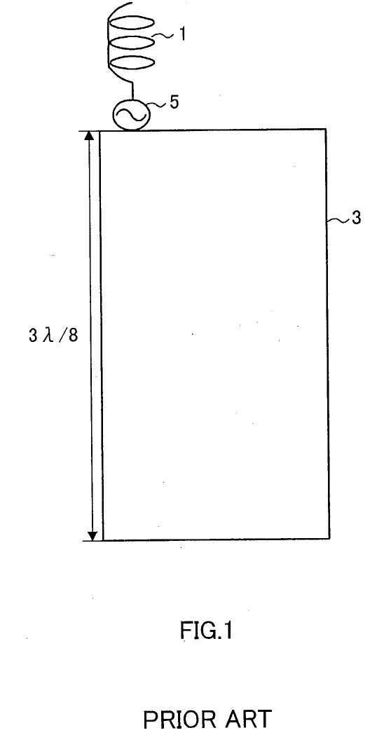

### BEST MODE FOR CARRYING OUT THE INVENTION

With reference now to the attached drawings, embodiments of the present invention will be explained in detail below.

(Embodiment 1)

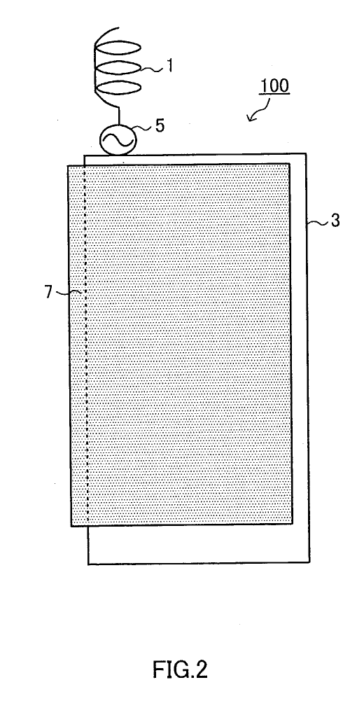

FIG. 2 is a block diagram showing a configuration of an antenna apparatus for a radio set according to Embodiment 1 of the present invention.

This antenna apparatus 100 is an unbalanced power supply type antenna apparatus for a cellular phone set and is provided with a power-supplied antenna element 1, a base plate 3 such as a circuit board and a tabular parasitic element 7.

The antenna element 1 can have any shape such as linear, spiral or tabular. The figure shows an example of a spiral shape. Power is supplied to the antenna element 1 through a power supply section 5. When, for example, a spiral antenna element is used, it is possible to reduce the size of the antenna element compared to a linear one. On the other hand, when a tabular antenna element is used, it is possible to reduce the size of the antenna element compared to a linear one, and it is also possible to build the tabular antenna element in the antenna element.

In the case of an unbalanced power supply system, a current also flows through the base plate 3 during a communication. The length of the base plate 3 (base plate length) varies depending on the frequency band of the system used or model of each cellular phone set, but it is approximately ⅜ wavelength for an 800 MHz band.

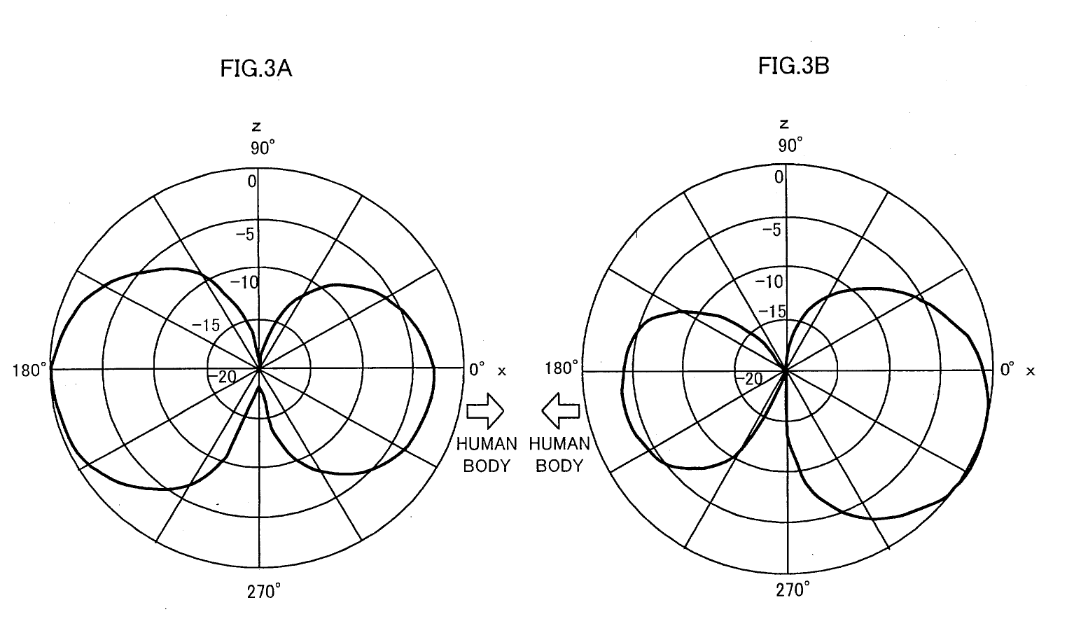

The tabular parasitic element 7 is placed along the base plate 3 and the length of the element is set so that the tabular parasitic element operates as a reflector or a wave director according to the positional relationship between the base plate 3 and tabular parasitic element 7 with respect to the human body. More specifically, when the tabular parasitic element 7 is placed on the human body side (the base plate 3 is placed on the opposite side of the human body in this case), the tabular parasitic element 7 is allowed to operate as a reflector so as to have an emission characteristic (directivity) as shown in FIG. 3A and when the tabular parasitic element 7 is placed on the opposite side of the human body (the base plate 3 is placed on the human body side in this case), the tabular parasitic element 7 is allowed to operate as a wave director so as to have an emission characteristic (directivity) as shown in FIG. 3B. As is well known, a parasitic element generally operates as a wave director when it is shorter than an emission element and operates as a reflector when it is longer than an emission element. In this case, by adjusting the length of the tabular parasitic element 7 with respect to the antenna element 1 functioning as an emission element and base plate 3, it is possible to allow the tabular parasitic element 7 to operate as a reflector or wave director.

Thus, the antenna apparatus 100 of this embodiment provides an unbalanced power supply type antenna apparatus with the tabular parasitic element 7 placed along the base plate 3 and operates the tabular parasitic element 7 as a reflector when it is placed on the human body side and operates as a wave director when it is placed on the opposite side of the human body, and can thereby direct the emission directivity opposite the human body over a wide band (see FIG. 3A and FIG. 3B), reduce influences from the human body, improve the gain and reduce a non-absorption ratio (SAR) without narrowing the communication area.

(Embodiment 2)

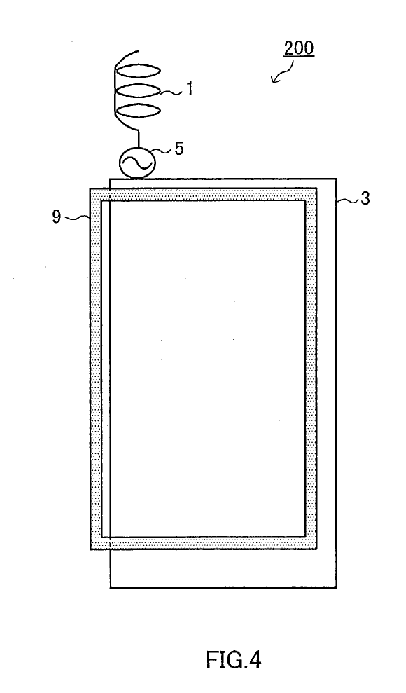

FIG. 4 is a block diagram showing a configuration of an antenna apparatus for a radio set according to Embodiment 2 of the present invention. This antenna apparatus 200 has the same basic configuration as that of the antenna apparatus 100 corresponding to Embodiment 1 shown in FIG. 2, and therefore the same components are assigned the same reference numerals and explanations thereof will be omitted.

A feature of the antenna apparatus 200 shown in FIG. 4 is to use a frame-shaped parasitic element 9 instead of the tabular parasitic element 7 at the antenna apparatus 100 corresponding to Embodiment 1. The frame-shaped parasitic element 9 is placed along a base plate 3 and according to the positional relationship between the base plate 3 and tabular parasitic element 7 with respect to the human body, the length of the frame-shaped parasitic element is set so that the frame-shaped parasitic element operates as a reflector when the frame-shaped parasitic element 9 is placed on the human body side (see FIG. 3A) or a wave director when the frame-shaped parasitic element 9 is placed on the opposite side of the human body (see FIG. 3B).

Thus, the antenna apparatus 200 of this embodiment provides an unbalanced power supply type antenna apparatus with the frame-shaped parasitic element 9 placed along the base plate 3 and operates the frame-shaped parasitic element 9 as a reflector when it is placed on the human body side and as a wave director when it is placed on the opposite side of the human body, and can thereby direct the emission directivity opposite the human body over a wide band (see FIG. 3A and FIG. 3B), reduce influences from the human body, improve the gain and reduce a non-absorption ratio (SAR) without narrowing the communication area.

Furthermore, since the parasitic element 9 is frame-shaped, it is possible to construct the apparatus more simply than the tabular one (Embodiment 1) and provide an operation section and liquid crystal display, etc., on the same side as the parasitic element.

(Embodiment 3)

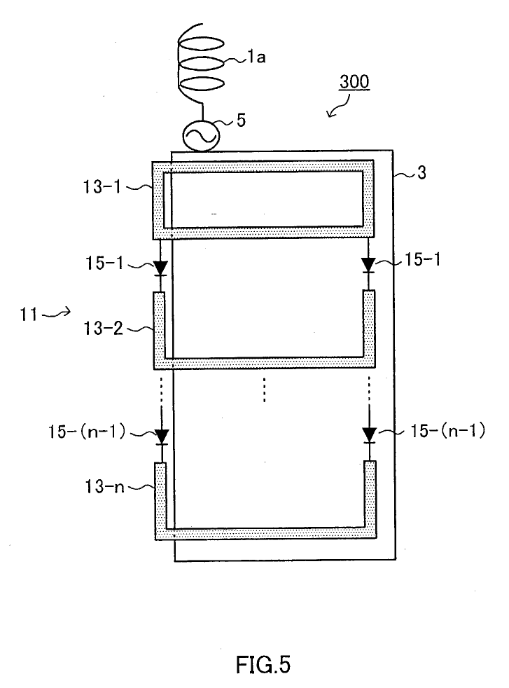

FIG. 5 is a block diagram showing a configuration of an antenna apparatus for a radio set according to Embodiment 3 of the present invention. This antenna apparatus 300 has the same basic configuration as that of the antenna apparatus 100 corresponding to Embodiment 1 shown in FIG. 2, and therefore the same components are assigned the same reference numerals and explanations thereof will be omitted.

A feature of the antenna apparatus 300 shown in FIG. 5 is to have a configuration applicable to a plurality of frequency bands. More specifically, a power-supplied antenna element la has a plurality (n) of resonance points corresponding to a plurality (n) of frequency bands, and a parasitic element 11 placed along a base plate 3 adopts a mode of a frame-shaped parasitic element body having as many (n) frame-shaped parasitic elements 13-1, 13-2, . . . , 13-n as resonance points in accordance with the antenna element 1a having a plurality (n) of resonance points.

As shown above, the frame-shaped parasitic element body 11 has as many (n) frame-shaped parasitic elements 13-1, 13-2, . . . , 13-n as resonance points. Between (n−1) neighboring frame-shaped parasitic elements 13, switching sections 15-1, 15-2, . . . , 15-(n−1) for switching ON/OFF states of conduction are inserted respectively. The switching sections 15-1 through 15-(n−1) can be any electric or electronic components, elements or circuits if they have at least the function of switching ON/OFF states of conduction. At this time, when, for example, conduction between all neighboring frame-shaped parasitic elements 13 is switched OFF, only the frame-shaped parasitic element 13-1 operates and can cover a first frequency band, and when only conduction between the neighboring frame-shaped parasitic elements 13-1 and 13-2 is switched ON, only the frame-shaped parasitic elements 13-1 and 13-2 operate and can cover a second frequency band, and when conduction between all neighboring frame-shaped parasitic elements 13 is switched ON, all the frame-shaped parasitic elements 13-1 through 13-n operate and can cover an nth frequency band. Thus, by sequentially switching conduction states between neighboring frame-shaped parasitic elements 13 and making the number of operating frame-shaped parasitic elements 13-1 through 13-n variable, it is possible to cover n frequency bands from the first frequency band to the nth frequency band.

Furthermore, the frame-shaped parasitic element body 11 in the above-described configuration is placed along the base plate 3, and as a positional relationship between the base plate 3 and the frame-shaped parasitic element body 11 with respect to the human body in respective frequency bands from the first to nth frequency bands, the lengths of the respective frame-shaped parasitic elements 13-1 through 13-n and the positions of the switching sections 15-1 through 15-(n−1) are set so that the frame-shaped parasitic element body 11 operates as a reflector (see FIG. 3A) when it is placed on the human body side and as a wave director (see FIG. 3B) when it is placed on the opposite side of the human body.

Thus, the antenna apparatus 300 of this embodiment provides an unbalanced power supply type antenna apparatus including the frame-shaped parasitic element body 11 placed along the base plate 3, which consists of frame-shaped parasitic elements 13 and switching sections 15 inserted between the neighboring frame-shaped parasitic elements 13, and operates the frame-shaped parasitic element body 11 as a reflector when it is placed on the human body side and as a wave director when it is placed on the opposite side of the human body, and can thereby direct the emission directivity opposite the human body over a wide band (see FIG. 3A and FIG. 3B) in a plurality of different (n) frequency bands, reduce influences from the human body, improve the gain and reduce a non-absorption ratio (SAR) without narrowing the communication area.

(Embodiment 4)

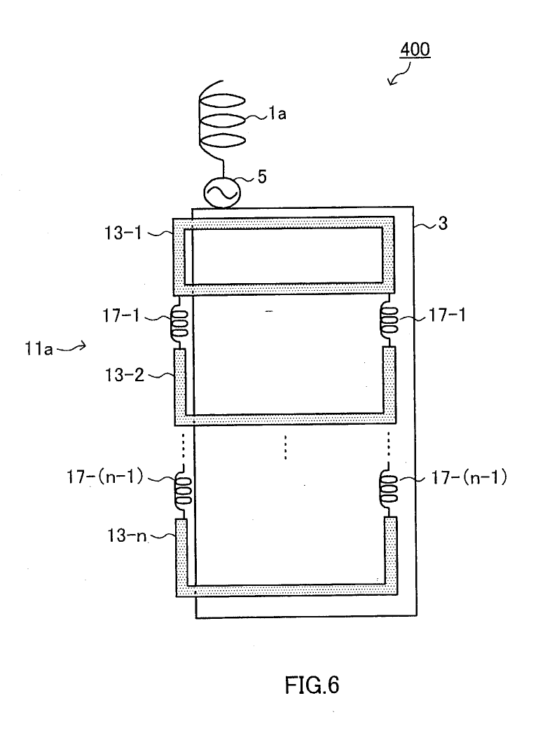

FIG. 6 is a block diagram showing a configuration of an antenna apparatus for a radio set according to Embodiment 4 of the present invention. This antenna apparatus 400 has the same basic configuration as that of the antenna apparatus 300 corresponding to Embodiment 3 shown in FIG. 5, and therefore the same components are assigned the same reference numerals and explanations thereof will be omitted.

A feature of the antenna apparatus 400 shown in FIG. 6 is to use inductive elements, for example, coils 17-1 through 17-(n−1) instead of the switching sections 15-1 through 15-(n−1). Here, constants (inductance) of the respective coils 17-1 through 17-(n−1) are set so that ON/OFF states of conduction between neighboring frame-shaped parasitic elements 13 are sequentially switched by means of high frequency in association with n frequency bands from the first to nth frequency bands and the number of operating frame-shaped parasitic elements 13-1 through 13-n is variable. The constants of the coils 17-1 through 17-(n−1) are set so that, for example, in the first frequency band, conduction between all neighboring frame-shaped parasitic elements 13 is switched OFF by means of high frequency and only the frame-shaped parasitic element 13-1 operates, in the second frequency band, only conduction between the neighboring frame-shaped parasitic elements 13-1 and 13-2 is switched ON by means of high frequency and only the frame-shaped parasitic elements 13-1 and 13-2 having inductive elements operate, and the same procedure is applied until in the nth frequency band, conduction between the neighboring frame-shaped parasitic elements is all switched ON by means of high frequency and all frame-shaped parasitic elements 13-1 through 13-n operate.

The frame-shaped parasitic element body 11a in the above-described configuration is placed along the base plate 3 and as a positional relationship between the base plate 3 and the frame-shaped parasitic element body 11a with respect to the human body in respective frequency bands from the first to nth frequency bands, the lengths of the respective frame-shaped parasitic elements 13-1 through 13-n and the constants of the coils 17-1 through 17-(n−1) are set so that the frame-shaped parasitic element body 11a operates as a reflector (see FIG. 3A) when it is placed on the human body side and as a wave director (see FIG. 3B) when it is placed on the opposite side of the human body.

Thus, the antenna apparatus 400 of this embodiment provides an unbalanced power supply type antenna apparatus with the frame-shaped parasitic element body 11a placed along the base plate 3, which consists of frame-shaped parasitic elements 13 and coils 17 inserted between the neighboring frame-shaped parasitic elements 13, and operates the frame-shaped parasitic element 11a as a reflector when it is placed on the human body side and as a wave director when it is placed on the opposite side of the human body, and can thereby direct the emission directivity opposite the human body over a wide band (see FIG. 3A and FIG. 3B) in a plurality of different (n) frequency bands, reduce influences from the human body, improve the gain and reduce a non-absorption ratio (SAR) without narrowing the communication area.

Furthermore, since the coils 17 are inserted between the neighboring frame-shaped parasitic elements 13 to switch ON/OFF conduction by means of high frequency, it is possible to construct the apparatus more simply than the case where the switching sections are provided to physically switch ON/OFF conduction (Embodiment 3).

(Embodiment 5)

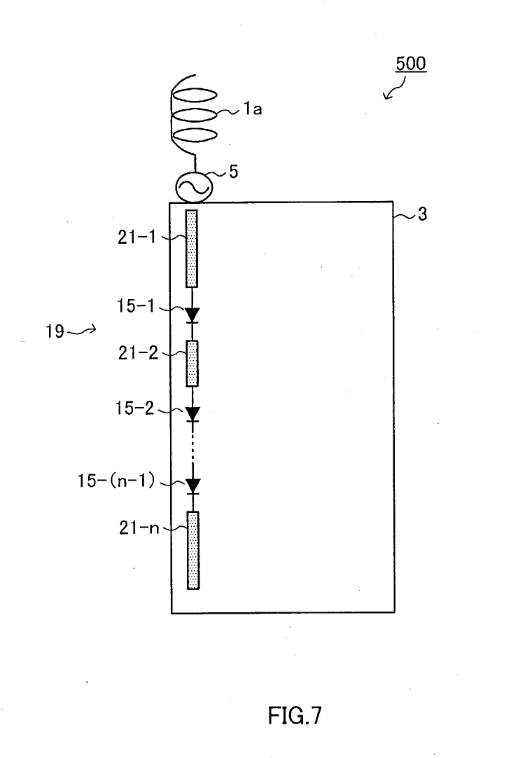

FIG. 7 is a block diagram showing a configuration of an antenna apparatus for a radio set according to Embodiment 5 of the present invention. This antenna apparatus 500 has the same basic configuration as that of the antenna apparatus 300 corresponding to Embodiment 3 shown in FIG. 5, and therefore the same components are assigned the same reference numerals and explanations thereof will be omitted.

A feature of the antenna apparatus 500 shown in FIG. 7 is to use a linear parasitic element body 19 instead of the frame-shaped parasitic element body 11 at the antenna apparatus 300 according to Embodiment 3. The linear parasitic element body 19 has as many (n) linear parasitic elements 21-1 through 21-n as resonance points. Between (n−1) neighboring linear parasitic elements 21, switching sections 15-1, 15-2, . . . , 15-(n−1) for switching ON/OFF states of conduction are inserted, respectively. The switching sections 15-1 through 15-(n−1) can be any electric or electronic components, elements or circuits such as a combination of diodes and switches or transistors, if they have at least the function of switching ON/OFF states of conduction. At this time, when, for example, conduction between all neighboring linear parasitic elements 21 is switched OFF, only the linear parasitic element 21-1 operates and can cover a first frequency band, and when only conduction between the neighboring linear parasitic elements 21-1 and 21-2 is switched ON, only the linear parasitic elements 21-1 an 21-2 operate and can cover a second frequency band, and when conduction between all neighboring linear parasitic elements is switched ON, all the linear parasitic elements 21-1 through 21-n operate and can cover an nth frequency band. Thus, by sequentially switching conduction states between neighboring linear parasitic elements 21 and making the number of operating linear parasitic elements 21-1 through 21-n variable, it is possible to cover n frequency bands from the first frequency band to the nth frequency band.

Furthermore, the linear parasitic element body 19 in the above-described configuration is placed substantially on an extension of the antenna element 1a along the base plate 3 and as a positional relationship between the base plate 3 and the linear parasitic element body 19 with respect to the human body in the respective frequency bands from the first to nth frequency bands, the lengths of the respective linear parasitic elements 21-1 through 21-n and the positions of the switching sections 15-1 through 15-(n−1) are set so that the linear parasitic element body 19 operates as a reflector (see FIG. 3A) when it is placed on the human body side and as a wave director (see FIG. 3B) when it is placed on the opposite side of the human body.

Thus, the antenna apparatus 500 of this embodiment provides an unbalanced power supply type antenna apparatus including the linear parasitic element body 19 placed along the base plate 3, which consists of linear parasitic elements 21 and switching sections inserted between the neighboring linear parasitic elements 21, and in the frequency bands from the first to nth frequency bands, operates the linear parasitic element body 19 as a reflector when it is placed on the human body side and as a wave director when it is placed on the opposite side of the human body, and can thereby direct the emission directivity opposite the human body over a wide band (see FIG. 3A and FIG. 3B) in a plurality of different (n) frequency bands, reduce influences from the human body, improve the gain and reduce a non-absorption ratio (SAR) without narrowing the communication area.

Furthermore, since the linear parasitic element body 19 consists of linear parasitic elements 21-1 through 21-n, it is possible to reduce the size of the apparatus compared to the case of frame-shaped parasitic elements (Embodiment 3).

Furthermore, since the linear parasitic element body 19 is placed substantially on an extension of the antenna element 1a, it is also possible to effectively cover a frequency band, which is likely to be generated substantially on the extension of the antenna element 1a by a current that flows through the base plate 3.

This embodiment uses the switching sections 15 to switch ON/OFF states of conduction between the neighboring linear parasitic elements 21, but this way is not limitative, and it is also possible to use inductive elements, for example, coils instead of the switching sections 15 as in the case of Embodiment 4. In this case, coils are inserted between the neighboring linear parasitic elements 21 and conduction is switched ON/OFF by means of high frequency, and therefore it is possible to construct the apparatus more simply than the case where conduction is physically switched ON/OFF by means of switching sections (Embodiment 5).

(Embodiment 6)

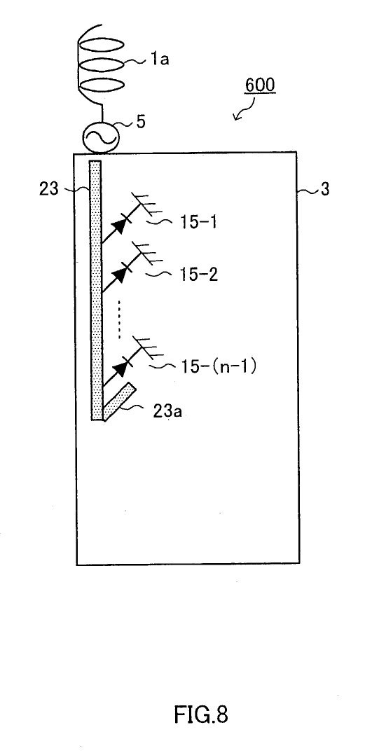

FIG. 8 is a block diagram showing a configuration of an antenna apparatus for a radio set according to Embodiment 6 of the present invention. This antenna apparatus 600 has the same basic configuration as that of the antenna apparatus 500 corresponding to Embodiment 5 shown in FIG. 7, and therefore the same components are assigned the same reference numerals and explanations thereof will be omitted.

A feature of the antenna apparatus 600 shown in FIG. 8 is to use a one-side-grounded linear parasitic element 23 instead of the linear parasitic element body 19 at the antenna apparatus 500 corresponding to Embodiment 5. The one-side-grounded linear parasitic element 23 has one end 23a grounded to a base plate 3 and is further grounded to the base plate 3 at as many (n) intermediate positions as resonance points through switching sections 15-1, 15-2, . . . , 15-(n−1) for switching ON/OFF states of conduction, respectively. The switching sections 15-1 through 15-(n−1) can be any electric or electronic components, elements or circuits such as a combination of diodes and switches or transistors, if they have at least the function of switching ON/OFF states of conduction. Thus, by sequentially switching ON/OFF states of conduction of the switching sections 15-1 through 15-(n−1) and making the effective lengths of operating linear parasitic elements 23 variable, it is possible to cover n frequency bands from the first to nth frequency bands.

Furthermore, the one-side-grounded linear parasitic element 23 in the above-described configuration is placed substantially on an extension of the antenna element 1a along the base plate 3 and as a positional relationship between the base plate 3 and the one-side-grounded linear parasitic element body 23 with respect to the human body in the respective frequency bands from the first to nth frequency bands, the length of the element and positions of the switching sections 15-1 through 15-(n−1) are set so that the one-side-grounded linear parasitic element 23 operates as a reflector (see FIG. 3A) when it is placed on the human body side and as a wave director (see FIG. 3B) when it is placed on the opposite side of the human body.

Thus, the antenna apparatus 600 of this embodiment provides an unbalanced power supply type antenna apparatus including the one-side-grounded linear parasitic element 23 placed along the base plate 3, whose one end 23a is grounded to the base plate 3 and further grounded to the base plate 3 at intermediate positions through the switching sections 15, and operates the one-side-grounded linear parasitic element 23 as a reflector when it is placed on the human body side and as a wave director when it is placed on the opposite side of the human body in the frequency bands from the first to nth frequency bands, and can there by direct the emission directivity opposite the human body over a wide band (see FIG. 3A and FIG. 3B) in a plurality of different (n) frequency bands, reduce influences from the human body, improve the gain and reduce a non-absorption ratio (SAR) without narrowing the communication area.

Furthermore, since the parasitic element 23 is linear, it is possible to reduce the size of the apparatus compared to the case of frame-shaped parasitic elements (Embodiment 3).

Furthermore, since it is only one one-side-grounded linear parasitic element 23 that is used, it is possible to further reduce the size of the apparatus compared to the case where a plurality of linear parasitic elements is used (Embodiment 5).

Furthermore, since the one-side-grounded linear parasitic element 23 is placed substantially on an extension of the antenna element 1a, it is also possible to effectively cover a frequency band, which is likely to be generated substantially on the extension of the antenna element la by a current that flows through the base plate 3.

(Embodiment 7)

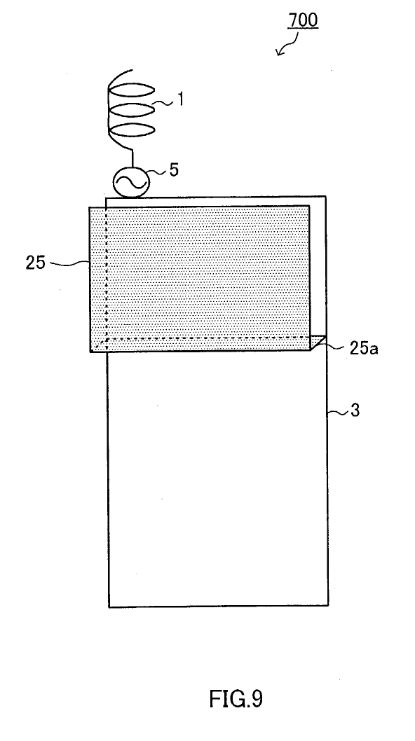

FIG. 9 is a block diagram showing a configuration of an antenna apparatus for a radio set according to Embodiment 7 of the present invention. This antenna apparatus 700 has the same basic configuration as that of the antenna apparatus 100 corresponding to Embodiment 1 shown in FIG. 2, and therefore the same components are assigned the same reference numerals and explanations thereof will be omitted.

A feature of the antenna apparatus 700 shown in FIG. 9 is to use a one-side-grounded tabular parasitic element 25 instead of the tabular parasitic element 7 at the antenna apparatus 100 according to Embodiment 1. The one-side-grounded tabular parasitic element 25 is placed along the base plate 3 and has one end 25a grounded to a base plate 3. The length of the one-side-grounded tabular parasitic element 25 is set so that as the positional relationship between the base plate 3 and the one-side-grounded tabular parasitic element 25 with respect to the human body, the one-side-grounded tabular parasitic element 25 operates as a reflector (see FIG. 3A) when it is placed on the human body side and as a wave director (see FIG. 3B) when it is placed on the opposite side of the human body.

Thus, the antenna apparatus 700 of this embodiment provides an unbalanced power supply type antenna apparatus including the one-side-grounded tabular parasitic element 25 placed along the base plate 3, whose one end 25a is grounded to the base plate 3, and operates the one-side-grounded tabular parasitic element 25 as a reflector when it is placed on the human body side and as a wave director when it is placed on the opposite side of the human body, and can thereby direct the emission directivity opposite the human body over a wide band (see FIG. 3A and FIG. 3B), reduce influences from the human body, improve the gain and reduce a non-absorption ratio (SAR) without narrowing the communication area.

Furthermore, since the one end 25a of the one-side-grounded tabular parasitic element 25 is grounded, it is possible to reduce the size of the apparatus compared to the case where the one end is not grounded (Embodiment 1).

(Embodiment 8)

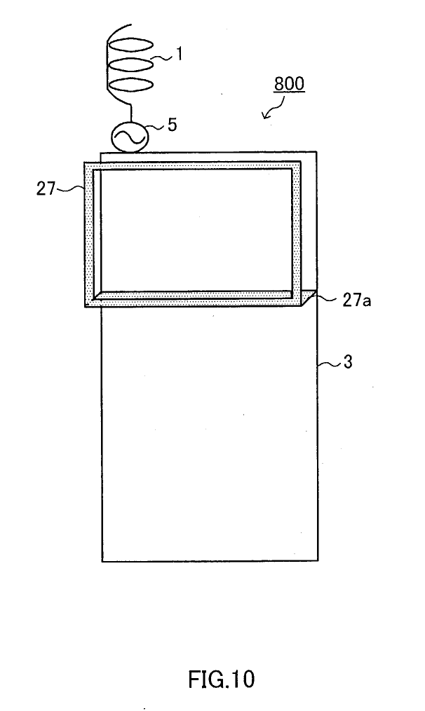

FIG. 10 is a block diagram showing a configuration of an antenna apparatus for a radio set according to Embodiment 8 of the present invention. This antenna apparatus 800 has the same basic configuration as that of the antenna apparatus 700 corresponding to Embodiment 7 shown in FIG. 9, and therefore the same components are assigned the same reference numerals and explanations thereof will be omitted.

A feature of the antenna apparatus 800 shown in FIG. 10 is to use a one-side-grounded frame-shaped parasitic element 27 instead of the one-side-grounded tabular parasitic element 25 at the antenna apparatus 700 according to Embodiment 7. The one-side-grounded frame-shaped parasitic element 27 is placed along the base plate 3 and has one end 27a grounded to a base plate 3. The length of the one-side-grounded frame-shaped parasitic element 27 is set so that as the positional relationship between the base plate 3 and the one-side-grounded frame-shaped parasitic element 27 with respect to the human body, the one-side-grounded frame-shaped parasitic element 27 operates as a reflector (see FIG. 3A) when it is placed on the human body side and as a wave director (see FIG. 3B) when it is placed on the opposite side of the human body.

Thus, the antenna apparatus 800 of this embodiment provides an unbalanced power supply type antenna apparatus including the one-side-grounded frame-shaped parasitic element 27 placed along the base plate 3, whose one end 27a is grounded to the base plate 3, and operates the one-side-grounded frame-shaped parasitic element 27 as a reflector when it is placed on the human body side and as a wave director when it is placed on the opposite side of the human body, and can there by direct the emission directivity opposite the human body over a wide band (see FIG. 3A and FIG. 3B), reduce influences from the human body, improve the gain and reduce a non-absorption ratio (SAR) without narrowing the communication area.

Furthermore, since the one end 27a of the tabular parasitic element 27 is grounded, it is possible to reduce the size of the apparatus compared to the case where the one end is not grounded (Embodiment 2).

Furthermore, since the parasitic element 27 is frame-shaped, it is possible to construct the apparatus more simply than the tabular one (Embodiment 7) and provide an operation section and liquid crystal display, etc., on the same side as the parasitic element.

(Embodiment 9)

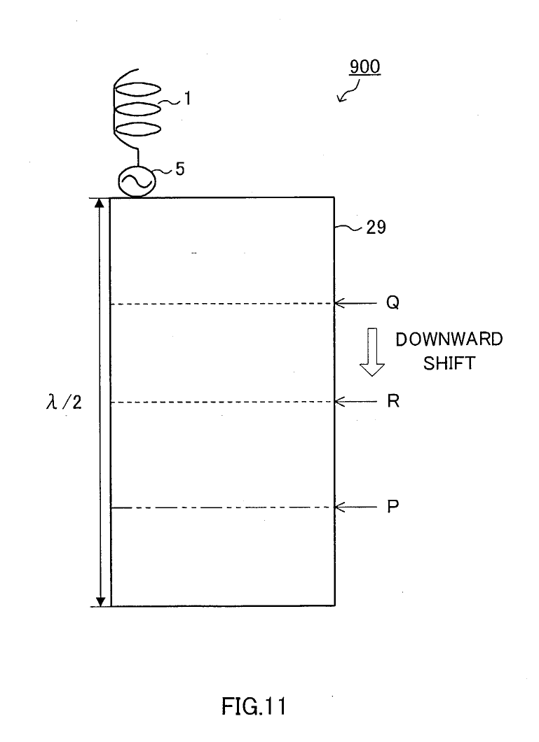

FIG. 11 is a block diagram showing a configuration of an antenna apparatus for a radio set according to Embodiment 9 of the present invention.

This antenna apparatus 900 is an unbalanced power supply type antenna apparatus for a cellular phone set and includes a power-supplied antenna element 1 and a base plate 29 such as a circuit board.

As shown above, the antenna element 1 can have any shape such as linear, spiral or tabular. The figure shows an example of a spiral antenna element. Power is supplied to the antenna element 1 through a power supply section 5.

In this embodiment, the length of the base plate 29 (base plate length) is not substantially ⅜ wavelength (position P in the figure), which is conventionally a general length, but is set to substantially ½ wavelength. Since the peak point of a current distribution is ¼-wavelength from the bottom of the base plate, setting the base plate length to substantially ½ wavelength as in the case of the base plate 29 that corresponds to this embodiment makes it possible to shift the peak point of the distribution of a current that flows through the base plate 29 downward. For example, suppose a position Q in the figure is a peak point of the current distribution in the case where the base plate length is ⅜ wavelength and a position R in the figure is a peak point of the current distribution in the case where the base plate length is ½ wavelength. Then, the peak point of the distribution of the current that flows through the base plate will shift downward from the position Q to the position R as shown in FIG. 11. As a result, the peak point of the current distribution goes away from the human body.

Thus, the antenna apparatus 900 of this embodiment provides an unbalanced power supply type antenna apparatus including the base plate 29 having a length of substantially ½ wavelength, and can thereby shift the peak point of the distribution of the current that flows through the base plate 29 downward on the base plate, increase the distance between the peak point of the current distribution and the human body and reduce a non-absorption ratio (SAR) without narrowing the communication area.

(Embodiment 10)

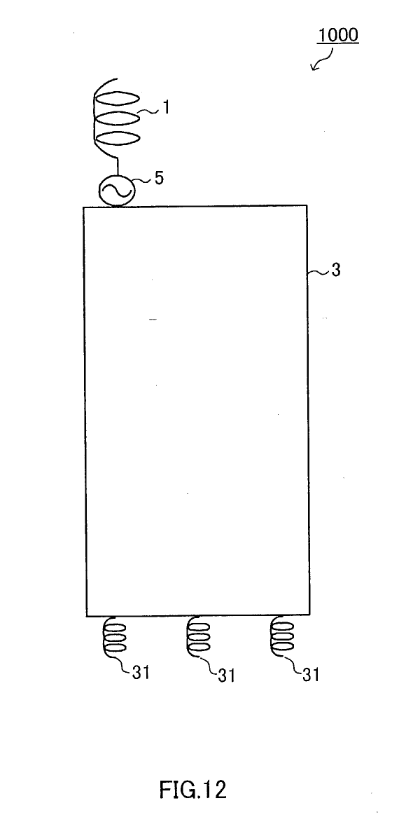

FIG. 12 is a block diagram showing a configuration of an antenna apparatus for a radio set according to Embodiment 10 of the present invention. This antenna apparatus 1000 has the same basic configuration as that of the antenna apparatus 900 corresponding to Embodiment 9 shown in FIG. 11, and therefore the same components are assigned the same reference numerals and explanations thereof will be omitted.

A feature of the antenna apparatus 1000 shown in FIG. 12 is to provide extension elements to electrically extend the base plate length at the bottom of a base plate 3 and electrically set the length of the base plate 3 to substantially ½ wavelength. More specifically, for example by allowing the physical length of the base plate 3 to remain substantially ⅜ wavelength and attaching spiral coils (helical coils) 31 at the bottom of the base plate 3 as extension elements, the length of the base plate 3 is electrically (that is, equivalently) set to substantially ½ wavelength.

Thus, the antenna apparatus 1000 of this embodiment provides an unbalanced power supply type antenna apparatus with helical coils 31 attached at the bottom of the base plate 3 so that the length of the base plate 3 is electrically (that is, equivalently) set to substantially ½ wavelength, and can thereby shift the peak point of a distribution of a current that flows through the base plate 3 downward, increase the distance between the peak point of the current distribution and the human body and reduce a non-absorption ratio (SAR) without narrowing the communication area.

Furthermore, since the length of the base plate 3 is electrically extended and equivalently set to substantially ½ wavelength, it is possible to shorten the physical length of the base plate and reduce the size of the apparatus compared to the case where no extension element is provided (Embodiment 9).

(Embodiment 11)

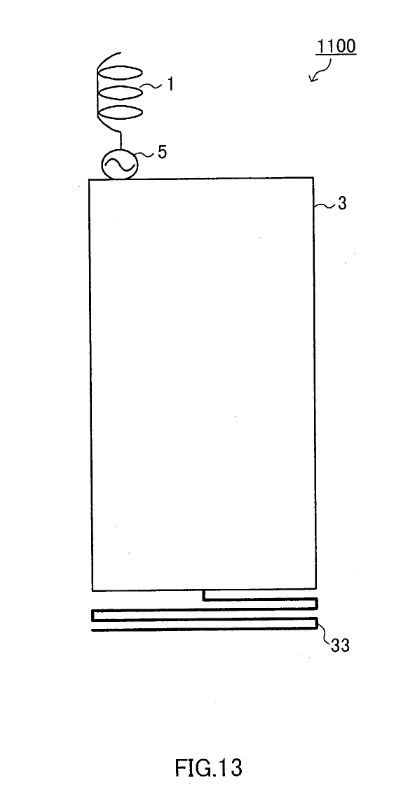

FIG. 13 is a block diagram showing a configuration of an antenna apparatus for a radio set according to Embodiment 11 of the present invention. This antenna apparatus 1100 has the same basic configuration as that of the antenna apparatus 1000 corresponding to Embodiment 10 shown in FIG. 12, and therefore the same components are assigned the same reference numerals and explanations thereof will be omitted.

A feature of the antenna apparatus 1100 shown in FIG. 13 is to use a meander line 33 instead of the helical coils 31 at the antenna apparatus 1000 that corresponds to Embodiment 10. The meander line 33 is attached at the bottom of a base plate 3 as an extension element, and as a result, the length of the base plate 3 is electrically set to substantially ½ wavelength.

Thus, the antenna apparatus 1100 of this embodiment provides an unbalanced power supply type antenna apparatus with the meander line 33 attached at the bottom of the base plate 3 so that the length of the base plate 3 is electrically (that is, equivalently) set to substantially ½ wavelength, and can thereby shift the peak point of a distribution of a current that flows through the base plate 3 downward, increase the distance between the peak point of the current distribution and the human body and reduce a non-absorption ratio (SAR) without narrowing the communication area.

Furthermore, since the length of the base plate 3 is electrically extended and equivalently set to substantially ½ wavelength, it is possible to shorten the physical length of the base plate and reduce the size of the apparatus compared to the case where no extension element is provided (Embodiment 9).

Furthermore, since the meander line 33 is used as the extension element, it is possible to equivalently set the length of the base plate 3 to substantially ½ wavelength in a simpler configuration than the case where the helical coils 31 are used (Embodiment 10).

The above-described embodiments have explained the case where the present invention is applied to an unbalanced power supply type antenna element for a cellular phone set, but the present invention is not limited to this and the present invention is also applicable to any portable type communication terminal apparatus.

As explained above, the present invention can not only reduce influences from the human body and improve the gain but also reduce a non-absorption ratio (SAR) without narrowing the communication area.

This application is based on the Japanese Patent Application No.2001-241381 filed on Aug. 8, 2001, entire content of which is expressly incorporated by reference herein.

### INDUSTRIAL APPLICABILITY

The present invention is applicable to an antenna apparatus for a radio set mounted on a portable type communication terminal apparatus such as a cellular phone set or mobile radio apparatus.

What is claimed is:

1. An antenna apparatus for a radio set comprising:
a power-supplied antenna element;
a base plate; and
a tabular parasitic element placed along said base plate, wherein the length of said tabular parasitic element is set so that said tabular parasitic element operates as a reflector when placed on the human body side with respect to said base plate and operates as a wave director when placed on the opposite side of the human body.

2. An antenna apparatus for a radio set comprising:
a power-supplied antenna element;
a base plate; and
a frame-shaped parasitic element placed along said base plate, wherein the length of said frame-shaped parasitic element is set so that said frame-shaped parasitic element operates as a reflector when placed on the human body side with respect to said base plate and operates as a wave director when placed on the opposite side of the human body.

3. An antenna apparatus for a radio set comprising:
a power-supplied antenna element having a plurality of resonance points corresponding to a plurality of frequency bands;
a base plate; and
a frame-shaped parasitic element body having as many frame-shaped parasitic elements as resonance points placed along said base plate, wherein said frame-shaped parasitic element body is provided with switching sections for switching ON/OFF states of conduction between neighboring frame-shaped parasitic elements, and the length of each frame-shaped parasitic element and the location of each switching section are set so that said frame-shaped parasitic element body operates as a reflector when placed on the human body side with respect to said base plate and operates as a wave director when placed on the opposite side of the human body.

4. An antenna apparatus for a radio set comprising:
a power-supplied antenna element having a plurality of resonance points corresponding to a plurality of frequency bands;
a base plate; and
a frame-shaped parasitic element body having as many frame-shaped parasitic elements as resonance points placed along said base plate, wherein said frame-shaped parasitic element body is provided with inductive elements for switching ON/OFF states of conduction between neighboring frame-shaped parasitic elements by means of high frequency, and the length of each frame-shaped parasitic element and a constant of each inductive element are set so that said frame-shaped parasitic element body operates as a reflector at each resonance point when placed on the human body side with respect to said base plate and operates as a wave director when placed on the opposite side of the human body.

5. An antenna apparatus for a radio set comprising:
a power-supplied antenna element having a plurality of resonance points corresponding to a plurality of frequency bands;
a base plate; and
a linear parasitic element body having as many linear parasitic elements as resonance points placed along said base plate, wherein said linear parasitic element body is provided with switching sections for switching ON/OFF states of conduction between neighboring linear parasitic elements, and the length of each linear parasitic element and the location of each switching section are set so that said linear parasitic element body operates as a reflector at each resonance point when placed on the human body side with respect to said base plate and operates as a wave director when placed on the opposite side of the human body.

6. The antenna apparatus for a radio set according to claim 5, wherein said linear parasitic element body is placed substantially on an extension of said antenna element.

7. An antenna apparatus for a radio set comprising:
a power-supplied antenna element having a plurality of resonance points corresponding to a plurality of frequency bands;
a base plate; and
a one-side-grounded linear parasitic element placed along said base plate, whose one end is grounded to said base plate, wherein said one-side-grounded linear parasitic element is grounded to said base plate through switching sections for switching ON/OFF states of conduction at as many intermediate positions as resonance points, and the length of the element and the location of each switching section are set so that said one-side-grounded linear parasitic element operates as a reflector at each resonance point when placed on the human body side with respect to said base plate and operates as a wave director at each resonance point when placed on the opposite side of the human body.

8. The antenna apparatus for a radio set according to claim 7, wherein said linear parasitic element is placed substantially on an extension of said antenna element.

9. An antenna apparatus for a radio set comprising:
a power-supplied antenna element;
a base plate; and
a one-side-grounded tabular parasitic element placed along said base plate whose one end is grounded to said base plate, wherein the length of said one-side-grounded tabular parasitic element is set so that said one-side-grounded tabular parasitic element operates as a reflector when placed on the human body side with respect to said base plate and operates as a wave director when placed on the opposite side of the human body.

10. An antenna apparatus for a radio set comprising:
a power-supplied antenna element; a base plate; and
a one-side-grounded frame-shaped parasitic element placed along said base plate, whose one end is grounded to said base plate, wherein the length of said one-side-grounded frame-shaped parasitic element is set so that said one-side-grounded frame-shaped parasitic element operates as a reflector when placed on the human body side with respect to said base plate and operates as a wave director when placed on the opposite side of the human body.

11. An antenna apparatus for a radio set comprising:
a power-supplied antenna element; and
a base plate, wherein said base plate has a length of substantially ½ wavelength.

12. An antenna apparatus for a radio set comprising:
a power-supplied antenna element; and
a base plate, wherein said base plate is provided with an extension element at the bottom to electrically extend the length of said base plate to substantially ½ wavelength.

13. The antenna apparatus for a radio set according to claim 12, wherein said extension element is a helical coil.

14. The antenna apparatus for a radio set according to claim 12, wherein said extension element is a meander line.
